(19) United States
(12) Patent Application Publication
(10) Pub. No.: US 2025/0193663 A1
(43) Pub. Date: Jun. 12, 2025

(54) Method and Apparatus for Performing Secondary Authentication/Authorization for Terminal Device in Communication Network

(71) Applicant: Telefonaktiebolaget LM Ericsson (publ), Stockholm (SE)

(72) Inventor: Hongxia Long, Shanghai (CN)

(21) Appl. No.: 18/845,509

(22) PCT Filed: Mar. 27, 2023
(86) PCT No.: PCT/CN2023/084084

§ 371 Date: Sep. 10, 2024

(30) Foreign Application Priority Data
Mar. 29, 2022 (WO) PCT/CN2022/083774

(51) Int. Cl. H04W 12/06; H04L 9/40; H04W 12/08

(52) U.S. Cl. CPC H04W 12/06; H04L 63/0892; H04W 12/08

(57) ABSTRACT

Embodiments of the present disclosure provide a method and an apparatus for performing secondary authentication/authorization for a terminal device in a communication network. A method performed by a first network entity may comprise: receiving from a second network entity a message indicating at least one kind of a secondary authentication/authorization method. One of the at least one kind of a secondary authentication/authorization method is a service based interface, SBI, -based secondary authentication/authorization. According to embodiments of the present disclosure, a dynamic selection of a kind of secondary authentication/authorization from a plurality of kinds may be achieved.

### TECHNICAL FIELD

The present disclosure relates generally to the technology of communication, and in particular, to a method and an apparatus for performing secondary authentication/authorization for a terminal device in a communication network.

### BACKGROUND

This section introduces aspects that may facilitate better understanding of the present disclosure. Accordingly, the statements of this section are to be read in this light and are not to be understood as admissions about what is in the prior art or what is not in the prior art.

A secondary authentication/authorization mechanism is defined in third generation partnership project (3GPP) standards (such as in 3GPP TS 23.502 V17.3.0). For example, 3GPP TS 23.502 section 4.3.2.3 specifies that the PDU Session establishment authentication/authorization is optionally triggered by the SMF during a PDU Session establishment and performed transparently via a UPF or directly with the DN-AAA server without involving the UPF if the DN-AAA server is located in the 5GC and reachable directly.

In this mechanism, only a DN-AAA based secondary authentication/authorization is usable.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In some use cases, a secondary authentication/authorization other than the DN-AAA based manner may be desired. However, current mechanism as defined in the 3GPP standards only support DN-AAA based manner. Therefore, an enhanced mechanism may be needed.

Certain aspects of the present disclosure and their embodiments may provide solutions to these or other challenges. There are, proposed herein, various embodiments which address one or more of the issues disclosed herein. Specific method and apparatus for performing secondary authentication/authorization for a terminal device in a communication network may be provided. Accordingly, an enhanced mechanism for performing secondary authentication/authorization may be provided.

A first aspect of the present disclosure provides a method performed by a first network entity. The method comprises receiving from a second network entity a message indicating at least one kind of a secondary authentication/authorization method. One of the at least one kind of a secondary authentication/authorization method is a service based interface, SBI, -based secondary authentication/authorization.

In embodiments of the present disclosure, the at least one kind of the secondary authentication/authorization method further comprises another kind of a data network-authentication, authorization and accounting, DN-AAA, based secondary authentication/authorization method.

In embodiments of the present disclosure, the method may further comprise checking the message to decide whether the secondary authentication/authorization is required and/or which kind of secondary authentication/authorization method is to be used.

In embodiments of the present disclosure, the method may further comprise requesting a third network entity to perform the secondary authentication/authorization based on the kind of secondary authentication/authorization method.

In embodiments of the present disclosure, the message may further include access information for the first network entity to access the third network entity.

In embodiments of the present disclosure, the message includes a first indication for the SBI-based secondary authentication/authorization method.

In embodiments of the present disclosure, the message includes a second indication for a DN-AAA based secondary authentication/authorization method.

In embodiments of the present disclosure, the message may indicate a DN-AAA based secondary authentication/authorization method. The third network entity may be a DN-AAA server. The message may include access information for the first network entity to access the DN-AAA server.

In embodiments of the present disclosure, the access information may include at least one of: an address of the DN-AAA server, an additional address of the DN-AAA server, or a domain name of the DN-AAA server.

In embodiments of the present disclosure, the first network entity may access the third network entity directly or via a user plane function, UPF.

In embodiments of the present disclosure, the message may indicate an SBI-based secondary authentication/authorization method. The third network entity may be an SBI-AAA server. The message may include access information for the first network entity to access the SBI-AAA server. The first network entity initializes an SBI based authentication/authorization towards the SBI-AAA server, when the first network entity requests the third network entity to perform the secondary authentication/authorization.

In embodiments of the present disclosure, the access information may include at least one of: an address of the SBI-AAA server, an additional address of the SBI-AAA server, a domain name of the SBI-AAA server, or an instance identity of the SBI-AAA server.

In embodiments of the present disclosure, the first network entity may access the third network entity directly or via a network exposure function, NEF.

In embodiments of the present disclosure, the first network entity comprises a session management function, SMF. The second network entity comprises a unified data management, UDM. The message may be a response to a request for session management data.

A second aspect of the present disclosure provides a method performed by a second network entity. The method comprises transmitting to a first network entity a message indicating at least one kind of a secondary authentication/authorization method. One of the at least one kind of a secondary authentication/authorization method is SBI-based secondary authentication/authorization.

In embodiments of the present disclosure, the at least one kind of the secondary authentication/authorization method further comprises another kind of a DN-AAA based secondary authentication/authorization method.

In embodiments of the present disclosure, the first network entity checks the message to decide whether the secondary authentication/authorization is required and/or which kind of secondary authentication/authorization method is to be used.

In embodiments of the present disclosure, the first network entity requests a third network entity to perform the secondary authentication/authorization based on the kind of secondary authentication/authorization method.

In embodiments of the present disclosure, the message may further include access information for the first network entity to access the third network entity.

In embodiments of the present disclosure, the message includes a first indication for an SBI-based secondary authentication/authorization method.

In embodiments of the present disclosure, the message includes a second indication for a DN-AAA based secondary authentication/authorization method.

In embodiments of the present disclosure, the message may indicate a DN-AAA based secondary authentication/authorization method. The third network entity may be a DN-AAA server. The message may include access information for the first network entity to access the DN-AAA server.

In embodiments of the present disclosure, the access information may include at least one of: an address of the DN-AAA server, an additional address of the DN-AAA server, or a domain name of the DN-AAA server.

In embodiments of the present disclosure, the first network entity may access the third network entity directly or via a user plane function, UPF.

In embodiments of the present disclosure, the message may indicate an SBI-based secondary authentication/authorization method. The third network entity may be an SBI-AAA server. The message may include access information for the first network entity to access the SBI-AAA server. The first network entity may initialize an SBI based authentication/authorization towards the SBI-AAA server, when the first network entity requests a third network entity to perform the secondary authentication/authorization.

In embodiments of the present disclosure, the access information may include at least one of: an address of the SBI-AAA server, an additional address of the SBI-AAA server, a domain name of the SBI-AAA server, or an instance identity of the SBI-AAA server.

In embodiments of the present disclosure, the first network entity may access the third network entity directly or via a network exposure function, NEF.

In embodiments of the present disclosure, the first network entity comprises a session management function, SM. The second network entity comprises a unified data management, UDM. The message may be a response to a request for session management data.

A third aspect of the present disclosure provides an apparatus for a first network entity in a communication network. The apparatus comprises: a processor, and a memory. The memory contains instructions executable by the processor. The apparatus for the first network entity is operative for receiving from a second network entity a message indicating at least one kind of a secondary authentication/authorization method. One of the at least one kind of a secondary authentication/authorization method is a service based interface, SBI, -based secondary authentication/authorization.

In embodiments of the present disclosure, the apparatus may be further operative to perform the method according to any embodiment above mentioned.

A fourth aspect of the present disclosure provides an apparatus for a first network entity in a communication network. The apparatus comprises: a processor, and a memory. The memory contain instructions executable by the processor. The apparatus for the first network entity is operative for: transmitting to a first network entity a message indicating at least one kind of a secondary authentication/authorization method. One of the at least one kind of a secondary authentication/authorization method is SBI-based secondary authentication/authorization.

In embodiments of the present disclosure, the apparatus may be further operative to perform the method according to any embodiment above mentioned.

A fifth aspect of the present disclosure provides a computer-readable storage medium storing instructions. When the instructions are executed by at least one processor, cause the at least one processor to perform the method according to any embodiment above mentioned.

Embodiments herein afford many advantages. According to embodiments of the present disclosure, an improved manner for performing secondary authentication/authorization for a terminal device in a communication network may be provided. The kind of secondary authentication/authorization method to be performed may be selected from a plurality of kinds of secondary authentication/authorization method.

Particularly, methods of secondary authentication/authorization other than DN-AAA could be provided and the corresponding access information could be provided with the enhanced subscription data managed by UDM. When multiple methods of secondary authentication/authorization are available, which one shall be used and optionally with the access information for the selected method for the secondary authentication/authorization could be specified. SMF could determine the method of the secondary authentication/authorization to be used based received subscription data from UDM.

According to different use cases, a dynamic selection of a kind of secondary authentication/authorization from a plurality of kinds may be achieved. For example, a secondary authentication/authorization via UPF may be used in one case, and another secondary authentication/authorization via NEF may be used in another case.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a reference architecture for 5G network interworking with external data network which has DN-AAA deployed.

FIG. 2 is a reference logical architecture for 4G/5G interwork interworking with external data network which has not DN-AAA deployed.

FIG. 3 is a flow chart illustrating a method performed by a first network entity, in accordance with some embodiments of the present disclosure.

FIG. 4 is a flow chart illustrating a method performed by a second network entity, in accordance with some embodiments of the present disclosure.

FIG. 5A is a diagram showing detailed steps performed by a first network entity and a second network entity, according to embodiments of the present disclosure.

FIG. 5B is a diagram showing additional steps performed by a first network entity and a second network entity, according to embodiments of the present disclosure.

FIG. 6 is a block diagram showing an exemplary apparatus for a first network entity, which is suitable for perform the method according to embodiments of the disclosure.

FIG. 7 is a block diagram showing an exemplary apparatus for a second network entity, which is suitable for perform the method according to embodiments of the disclosure.

FIG. 8 is a block diagram showing an apparatus/computer readable storage medium, according to embodiments of the present disclosure.

FIG. 9A is a block diagram showing units of an exemplary apparatus for a first network entity, which is suitable for perform the method according to embodiments of the disclosure.

FIG. 9B is a block diagram showing units of an exemplary apparatus for a second network entity, which is suitable for perform the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such for an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network entity” used herein refers to a network device or network node or network function or any other devices (physical or virtual) in a communication network. For example, the network entity in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network entity may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

3GPP TS 33.501 further specified that SMF determines whether secondary authentication/authorization (i.e., authentication and authorization) is needed based on the session management subscription data from UDM. Especially section 11.1.2 step 7 specified that:

“The H-SMF obtains subscription data from the UDM for the given SUPI obtained from the AMF in step 5. The SMF checks the subscription data whether the secondary authentication is required and whether the UE request is allowed according to the user subscription and local policies. If not allowed, the H-SMF will reject UE's request via SM-NAS signalling and skip rest of the procedure. If secondary authentication is required, the SMF may also check whether the UE has been authenticated and/or authorized by the same DN, as indicated DNN in step 5, or the same AAA server in a previous PDU session establishment.”

3GPP TS 29.503 is the specification for Subscription data. Especially section 6.1.6.2.9 defined the subscription data (underlined below) related to secondary authentication and authorization, for example:
“secondaryAuth: Indicates whether secondary authentication and authorization is needed;
dnAaaAddress: The IP address of the DN-AAA server used for secondary authentication and authorization;
additionalDnAaaAddresses: Additional IP address of the DN-AAA server used for secondary authentication and authorization;
dnAaaFqdn: The FQDN of the DN-AAA server used for secondary authentication and authorization.”
   “Table 6.1.6.2.9-1: Definition of type DnnConfiguration”

| Attribute name | Data type | P | Cardinality | Description |
|---|---|---|---|---|
| pduSessionTypes | PduSessionTypes | M | 1 | Default/Allowed session types |
| sscModes | SscModes | M | 1 | Default/Allowed SSC modes |
| iwkEpsInd | IwkEpsInd | O | 0 . . . 1 | Indicates whether interworking with |
| | | | | EPS is subscribed: |
| | | | | true: Subscribed; |
| | | | | false: Not subscribed; |
| | | | | If this attribute is absent it means not |
| | | | | subscribed. |
| 5gQosProfile | SubscribedDefault | O | 0 . . . 1 | 5G QoS parameters associated to the |
| | Qos | | | session for a data network |
| sessionAmbr | Ambr | O | 0 . . . 1 | The maximum aggregated uplink and |
| | | | | downlink bit rates to be shared across |
| | | | | all Non-GBR QoS Flows in each PDU |
| | | | | Session |
| 3gppCharging | 3GppCharging | O | 0 . . . 1 | Subscribed charging characteristics |
| Characteristics | Characteristics | | | data associated to the session for a data |
| | | | | network. (NOTE 1) |
| staticIpAddress | array(IpAddress) | O | 1 . . . 2 | Subscribed static IP address(es) of the |
| | | | | IPv4 and/or IPv6 type |
| upSecurity | UpSecurity | O | 0 . . . 1 | When present, this IE shall indicate the |
| | | | | security policy for integrity protection |
| | | | | and encryption for the user plane. |
| pduSession | PduSession | O | 0 . . . 1 | When present, this IE shall indicate |
| ContinuityInd | ContinuityInd | | | how to handle a PDU Session when |
| | | | | UE the moves to or from NB-IoT. |
| | | | | If this attribute is absent it means that |
| | | | | Local policy shall be used. |
| niddNefId | NefId | C | 0 . . . 1 | Indicates the identity of the NEF to be |
| | | | | selected for NIDD service for this |
| | | | | DNN. It is required if |
| | | | | invokeNefSelection attribute is present |
| | | | | with value “true“. |
| niddInfo | NiddInformation | O | 0 . . . 1 | When present, this IE shall indicate |
| | | | | information used for SMF-NEF |
| | | | | Connection. |
| | | | | This attribute may be present if |
| | | | | “Invoke NEF Selection” indicator is |
| | | | | set. |
| redundantSession | boolean | O | 0 . . . 1 | Indicates whether redundant PDU |
| Allowed | | | | Sessions are allowed: |
| | | | | true: Allowed; |
| | | | | false: Not allowed; |
| | | | | If this attribute is absent it means not |
| | | | | allowed. |
| acsInfo | AcsInfo | O | 0 . . . 1 | When present, this IE shall include the |
| | | | | ACS information for the 5G-RG as |
| | | | | defined in BBF TR-069 [42] or in |
| | | | | BBF TR-369 [43]. |
| ipv4FrameRoute | array(FrameRout | O | 1 . . . N | List of Frame Route information of |
| List | eInfo) | | | IPv4, see clause 5.6.14 of |
| | | | | 3GPP TS 23.501 [2]. |
| ipv6FrameRoute | array(FrameRout | O | 1 . . . N | List of Frame Route information of |
| List | eInfo) | | | IPv6, see clause 5.6.14 of |
| | | | | 3GPP TS 23.501 [2]. |
| atsssAllowed | boolean | O | 0 . . . 1 | Indicates whether this DNN supports |
| | | | | ATSSS, i.e. whether Multi-Access |
| | | | | PDU session is allowed to this DNN. |
| | | | | true: Allowed; |
| | | | | false (default): Not allowed; |
| | | | | If this attribute is absent it means this |
| | | | | DNN does not allow ATSSS. |
| secondaryAuth | boolean | O | 0 . . . 1 | Indicates whether secondary |
| | | | | authentication and authorization is |
| | | | | needed. |
| | | | | true: required. |
| | | | | false: not required. |
| | | | | If absent, it indicates that secondary |
| | | | | authentication is not required by |
| | | | | subscription data, but it still may be |
| | | | | required by local policies at the SMF. |
| | | | | (NOTE 2) |
| dnAaaIpAddress | boolean | O | 0 . . . 1 | Indicates whether the SMF is required |
| Allocation | | | | to request the UE IP address from the |
| | | | | DN-AAA server for PDU Session |
| | | | | Establishment. |
| | | | | true: required |
| | | | | false: not required |
| | | | | If absent, it indicates that the request |
| | | | | by SMF of the UE IP address from the |
| | | | | DN-AAA server is not required by |
| | | | | subscription data, but it still may be |
| | | | | required by local policies at the SMF. |
| dnAaaAddress | IpAddress | O | 0 . . . 1 | The IP address of the DN-AAA server |
| | | | | used for secondary authentication and |
| | | | | authorization. |
| | | | | (NOTE 2) |
| additionalDnAaa | array(IpAddress) | O | 1 . . . N | Additional IP addresses of the DN- |
| Addresses | | | | AAA server used for secondary |
| | | | | authentication and authorization. |
| | | | | (NOTE 2) |
| dnAaaFqdn | Fqdn | O | 0 . . . 1 | The FQDN of the DN-AAA server |
| | | | | used for secondary authentication and |
| | | | | authorization. |
| | | | | (NOTE 2) |
| iptvAccCtrlInfo | string | O | 0 . . . 1 | The IPTV access control information |
| | | | | used in IPTV access procedure, see |
| | | | | clause 7.7.1.1.2 of |
| | | | | 3GPP TS 23.316 [37]. |
| ipv4Index | IpIndex | O | 0 . . . 1 | Indicates the “IP Index” (i.e. |
| | | | | information that identifies an address |
| | | | | pool or an external server) to be sent to |
| | | | | the SMF for allocation of an IPV4 |
| | | | | address to the UE, for this DNN |
| | | | | configuration. |
| ipv6Index | IpIndex | O | 0 . . . 1 | Indicates the “IP Index” (i.e. |
| | | | | information that identifies an address |
| | | | | pool or an external server) to be sent to |
| | | | | the SMF for allocation of an IPV6 |
| | | | | address to the UE, for this DNN |
| | | | | configuration. |
| ecsAddrConfigInfo | EcsAddrConfig | O | 0 . . . 1 | ECS Address Configuration Informatio |
| | Info | | | Parameters. See 3GPP TS 23.502 [3] |
| sharedEcsAddr | SharedDataId | O | 0 . . . 1 | Identifier of shared data. May be |
| ConfigInfoId | | | | present if ecsAddrConfigInfo is absent. |
| easDiscovery | boolean | O | 0 . . . 1 | Indicates whether the UE is authorized |
| Authorized | | | | to use 5GC assisted EAS discovery via |
| | | | | EASDF. |
| | | | | true: Authorized; |
| | | | | false (default): Not authorized; |
| | | | | See 3GPP TS 23.548 [60] |
| onboardingInd | boolean | O | 0 . . . 1 | Indicates whether the UE is allowed to |
| | | | | use this DNN for onboarding. UE |
| | | | | subscription allows, or does not allow |
| | | | | the UE to access the PLMN as the |
| | | | | Onboarding Network using PLMN |
| | | | | credentials (see clause 5.30.2.10.4.4 in |
| | | | | 3GPP TS 23.501 [2]). |
| | | | | false (default): not restricted to |
| | | | | onboarding only; |
| | | | | true: allowed for onboarding |
| | | | | only. |
| aerialUeInd | AerialUeIndication | O | 0 . . . 1 | This IE shall indicate Aerial service for |
| | | | | the UE is allowed or not allowed. |

NOTE 1:
When present, this attribute shall take precedence over the “3 gppChargingCharacteristics” attribute in the SessionManagementSubscriptionData level.
NOTE 2:
These attributes shall be consistent with the information received on the 5GVnGroupData (see clause 6.5.6.2.7), in the Nudm_PP API. If both FQDN and IP addresses are provided, the IP addresses should be preferred to target the DN-AAA server.

There are problems of above technologies.

As to problem 1, the secondaryAuth IE in the subscription data could indicate whether secondary authentication and authorization is needed or not, but it is only bound to DN-AAA based secondary authentication and authorization mechanism. The IEs dnAaaAdress/additionalDnAaaAddresses/dnAaaFqdn could be further provided to specify the address/FQDN of the DN-AAA server, but other methods for secondary authentication and authorization can't be supported.

As to problem 2, assuming multiple methods for secondary authentication and authorization are supported, not only the indication about whether secondary authentication and authorization is needed, but also corresponding access information will be needed. However, the current method cannot provide information about which method and probably corresponding auxiliary access information.

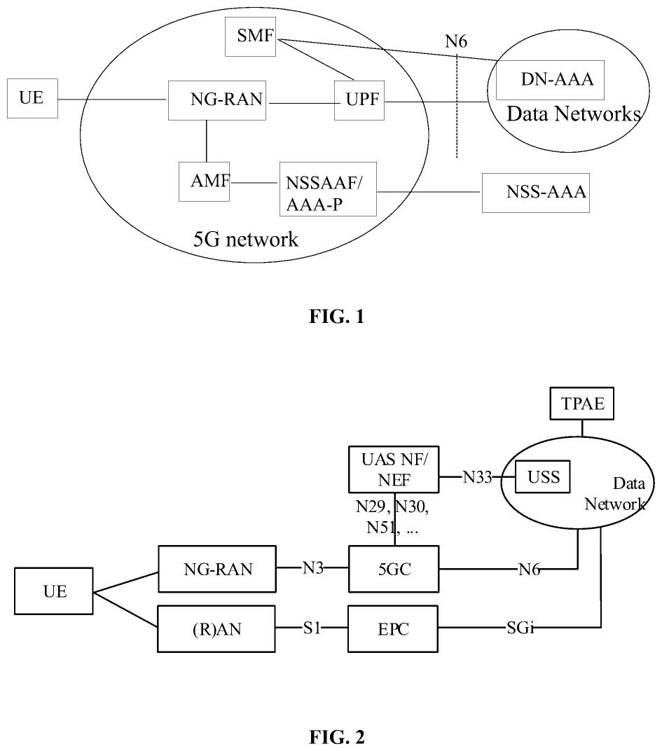

FIG. 1 is a reference architecture for 5G network interworking with external data network which has DN-AAA deployed. In this deployment scenario, if secondary authentication and authorization is required, the method of the secondary authentication and authorization is based on DN-AAA.

In this reference architecture, SMF may request the DN-AAA directly or via UPF (through N6 interface) to perform the secondary authentication and authorization for the UE. The reference architecture may further include network entities, such as NG-RAN, AMF, NSSAAF/AAA-P (Network Slice-Specific Authentication and Authorization Function/AAA Proxy), NSS-AAA (Network Slice-Specific Authentication, Authorization, and Accounting).

FIG. 2 is a reference logical architecture for 4G/5G interwork interworking with external data network which has not DN-AAA deployed.

Particularly, FIG. 2 is a reference logical architecture for 4G/5G interwork interworking with USS (UAS service supplier) in the data network to support Uncrewed Aerial Vehicle (UAV). In this deployment scenario, if secondary authentication and authorization is required, the method of the secondary authentication and authorization is based 3GPP SBI via NEF (Network Exposure Function)/UAS NF.

(R)AN is radio access network. 5GC is 5^{th} generation core network. EPC is evolved packet core network. N3, N6, N29, N30, N33, S1, SGi are interfaces. TPAE is Third Party Authorized Entity.

FIG. 1 and FIG. 2 is just for use case illustration but not an exhaustive list for all use cases. It is imaginable that the system deployed in the data network could support both DN-AAA based secondary authentication and authorization or SBI based secondary authentication and authorization, or even other new methods.

The embodiments of the present disclosure will provide method and apparatus for performing any of the above Secondary Authentication/Authorization methods for terminal device.

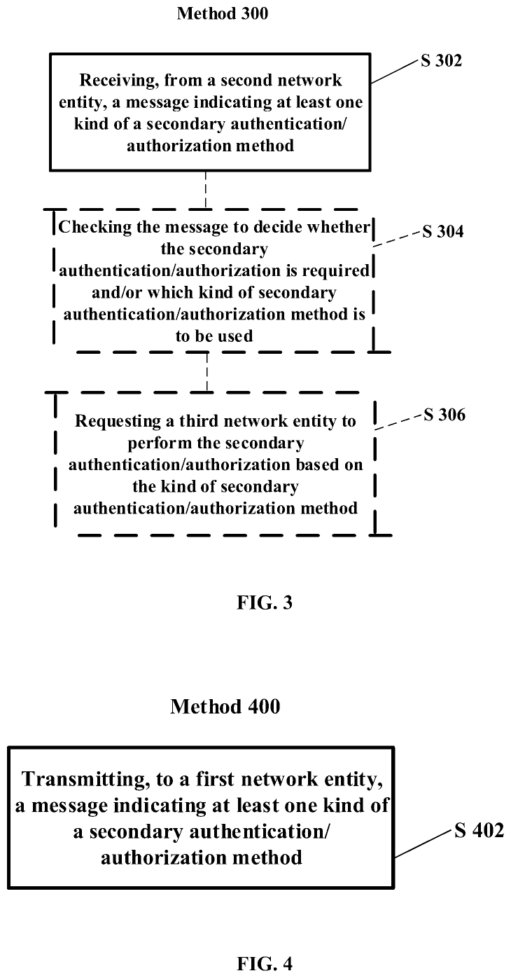

FIG. 3 is a flow chart illustrating a method performed by a first network entity, in accordance with some embodiments of the present disclosure. The optional steps may be illustrated in dashed blocks.

As shown in FIG. 3, the method 300 comprises: a step S302, receiving from a second network entity a message indicating at least one kind of a secondary authentication/authorization method. One of the at least one kind of a secondary authentication/authorization method is a service based interface, SBI, -based secondary authentication/authorization (i.e. SBI-based secondary authentication/authorization, or SBI AAA-based secondary authentication/authorization).

According to embodiments of the present disclosure, an improved manner for performing secondary authentication/authorization for a terminal device in a communication network may be provided. The kind of secondary authentication/authorization method to be performed may be selected from a plurality of kinds of secondary authentication/authorization method.

In embodiments of the present disclosure, the at least one kind of the secondary authentication/authorization method further comprises: another kind of a data network-authentication, authorization and accounting, DN-AAA, based secondary authentication/authorization method.

As shown in FIG. 3, the method 300 may further comprise: a step S304, checking the message to decide whether the secondary authentication/authorization is required and/or which kind of secondary authentication/authorization method is to be used; and/or a step S306, requesting a third network entity to perform the secondary authentication/authorization based on the kind of secondary authentication/authorization method.

In embodiments of the present disclosure, the message may further include access information for the first network entity to access the third network entity.

In embodiments of the present disclosure, the message may include the message includes a first indication for the SBI-based secondary authentication/authorization method.

In embodiments of the present disclosure, the message includes a second indication for a DN-AAA based secondary authentication/authorization method.

In embodiments of the present disclosure, the message may include a third indication. The third indication may have a first value to indicate the first kind of secondary authentication/authorization method (SBI-based secondary authentication/authorization, or DN-AAA based secondary authentication/authorization method), or may have a second value to indicate a second kind of secondary authentication/authorization method (DN-AAA based secondary authentication/authorization method, or SBI-based secondary authentication/authorization).

According to different use cases, a dynamic selection of a kind of secondary authentication/authorization from a plurality of kinds may be achieved. For example, a secondary authentication/authorization via UPF may be used in one case, and another secondary authentication/authorization via NEF may be used in another case.

In embodiments of the present disclosure, the message may indicate a DN-AAA based secondary authentication/authorization method. The third network entity may be a DN-AAA server. The message may include access information for the first network entity to access the DN-AAA server.

In embodiments of the present disclosure, the first access information may include at least one of: an address of the DN-AAA server; an additional address of the DN-AAA server; or a domain name of the DN-AAA server.

In embodiments of the present disclosure, the first network entity may access the third network entity directly or via a user plane function, UPF.

In embodiments of the present disclosure, the message may indicate the SBI-based secondary authentication/authorization method. The third network entity may be an SBI-AAA server. The message may include access information for the first network entity to access the SBI-AAA server. The step S306, requesting a third network entity to perform the secondary authentication/authorization, may comprise: initializing an SBI-AAA based authentication/authorization towards the SBI-AAA server.

In embodiments of the present disclosure, the access information may include at least one of: an address of the SBI-AAA server; an additional address of the SBI-AAA server; a domain name of the SBI-AAA server; or an instance identity of the SBI-AAA server.

In embodiments of the present disclosure, the first network entity may access the third network entity or via a network exposure function, NEF.

In embodiments of the present disclosure, the first network entity comprises a session management function, SMF. The second network entity comprises a unified data management, UDM. The message may be a response to a request for session management data. Further, the terminal device may be any kind of UE.

According to embodiments of the present disclosure, particularly, methods of secondary authentication/authorization other than DN-AAA could be provided and the corresponding access information could be provided with the enhanced subscription data managed by UDM. When multiple methods of secondary authentication/authorization are available, which one shall be used and optionally with the access information for the selected method for the secondary authentication/authorization could be specified. SMF could determine the method of the secondary authentication/authorization to be used based received subscription data from UDM.

FIG. 4 is a flow chart illustrating a method performed by a second network entity, in accordance with some embodiments of the present disclosure.

As shown in FIG. 4, the method 400 comprises: a step S402, transmitting to a first network entity a message indicating at least one kind of a secondary authentication/authorization method, wherein one of the at least one kind of a secondary authentication/authorization method is SBI-based secondary authentication/authorization.

In embodiments of the present disclosure, the at least one kind of the secondary authentication/authorization method further comprises another kind of a DN-AAA based secondary authentication/authorization method.

In embodiments of the present disclosure, the first network entity may check the message to decide whether the secondary authentication/authorization is required and/or which kind of secondary authentication/authorization method is to be used.

In embodiments of the present disclosure, the first network entity may request a third network entity to perform the secondary authentication/authorization based on the kind of secondary authentication/authorization method.

In embodiments of the present disclosure, the message may further include access information for the first network entity to access the third network entity.

In embodiments of the present disclosure, the message includes a first indication for an SBI-based secondary authentication/authorization method.

In embodiments of the present disclosure, the message includes a second indication for a DN-AAA based secondary authentication/authorization method.

In embodiments of the present disclosure, the message may include a third indication. The third indication may have a first value to indicate the first kind of secondary authentication/authorization method, or may have a second value to indicate a second kind of secondary authentication/authorization method.

In embodiments of the present disclosure, the message may indicate a DN-AAA based secondary authentication/authorization method. The third network entity may be a DN-AAA server. The message may include access information for the first network entity to access the DN-AAA server.

In embodiments of the present disclosure, the access information may include at least one of: an address of the DN-AAA server; an additional address of the DN-AAA server; or a domain name of the DN-AAA server.

In embodiments of the present disclosure, the first network entity may access the third network entity directly or via a user plane function, UPF.

In embodiments of the present disclosure, the message may indicate an SBI-based secondary authentication/authorization method. The third network entity may be an SBI-AAA server. The message may include access information for the first network entity to access the SBI-AAA server. The first network entity may initialize an SBI-AAA based authentication/authorization towards the SBI-AAA server, when the first network entity requests a third network entity to perform the secondary authentication/authorization.

In embodiments of the present disclosure, the access information may include at least one of: an address of the SBI-AAA server; an additional address of the SBI-AAA server; a domain name of the SBI-AAA server; or an instance identity of the SBI-AAA server.

In embodiments of the present disclosure, the first network entity may access the third network entity directly or via a network exposure function, NEF.

In embodiments of the present disclosure, the first network entity comprises a session management function, SM. The second network entity comprises a unified data management, UDM. The message may be a response to a request for session management data.

According to embodiments of the present disclosure, a new method may be provided to indicate the specific manner and corresponding access information which shall be used, if secondaryAuth IE in the UDM subscription data indicates that the secondary authentication and authorization is needed.

Particularly, UDM session management subscription data is enhanced to support indicating which method shall be used for secondary authentication and authorization when secondary Auth IE in the UDM session management subscription data indicates that the secondary authentication and authorization is needed. In addition, corresponding access information for the indicated method could be further provided.

The SMF obtains enhanced session management subscription data from the UDM. The SMF checks the subscription data whether the secondary authentication and authorization is required, and if it is required, the SMF also checks which methods for secondary authentication and authorization shall be used. For example, when the method is not DN-AAA based secondary authentication and authorization, the dnAaaAdress/dnAaaFqdn IEs shall not be used. Instead, the access information of the other method for the secondary authentication and authorization shall be checked.

SMF, based on the extended session management data, initiates either the DA-AAA based secondary authentication and authorization procedure, or the SBI-AAA based secondary authentication and authorization procedure.

That is, to solve the above problem 1, methods of secondary authentication and authorization other than DN-AAA could be provided and the corresponding access information could be provided with the enhanced subscription data managed by UDM.

To solve the above problem 2, if multiple methods of secondary authentication and authorization are available, which one shall be used could be specified and optionally with the access information for the selected method for the secondary authentication and authorization. SMF could determine the method of the secondary authentication and authorization to be used based received subscription data from UDM.

Overall, the embodiments may provide the method to the service operator to designate the method which shall be used for the secondary authentication and authorization during PDU session establishment for different services subscribed by different subscribers. In addition, as it is controlled by the session management subscription data, it can be changed dynamically through subscription management procedures, which provides more flexibility for service management and operation.

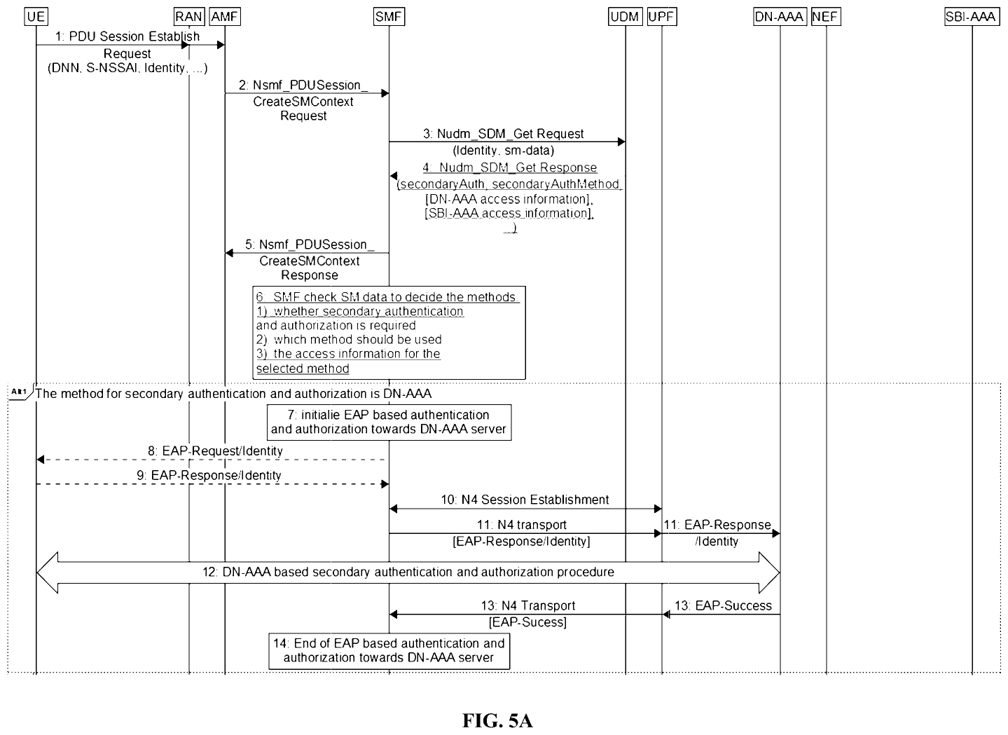

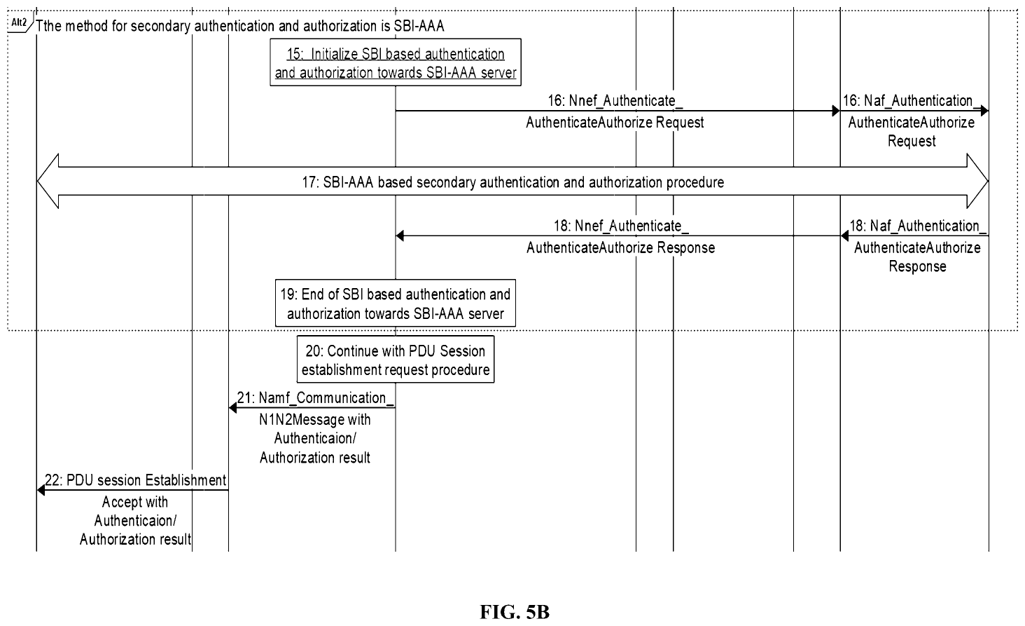

FIG. 5A is a diagram showing detailed steps performed by a first network entity and a second network entity, according to embodiments of the present disclosure. FIG. 5B is a diagram showing additional steps performed by a first network entity and a second network entity, according to embodiments of the present disclosure.

FIG. 5A, 5B shows Secondary Authentication and Authorization based on Enhanced session management subscription data (with new steps underlined). FIG. 5A, 5B depicts how SMF determines the method for the secondary authentication and authorization based on enhanced subsection data from UDM, the steps are described as below:

In step 1, the UE initiates the UE Requested PDU Session Establishment procedure by the transmission of a NAS message containing a PDU Session Establishment Request within the N1 SM container.

In step 2, if the AMF does not have an association with an SMF for the PDU Session ID (for example: 1) provided by the UE (e.g. when Request Type indicates “initial request”), the AMF invokes the Nsmf_PDUSession_CreateSMContext Request.

In step 3, if Session Management Subscription data for corresponding SUPI (Subscription Permanent Identifier) (for example: imsi-460001357924680), DNN (Data network name) (for example: “USS”} and S-NSSAI (Single Network Slice Selection Assistance Information) (for example: {sst (SliceServicetype): 128, sd (SliceDifferentiator): USS001}) of the HPLMN (Home Public Land Mobile Network) is not available, then SMF retrieves the Session Management Subscription data using Nudm_SDM_Get (SUPI, Session Management Subscription data, selected DNN, S-NSSAI of the HPLMN, Serving PLMN ID (for example: {mcc (Mobile Country Code): 460, mnc (Mobile Network Code): 00}, [NID] (Network Identifier) (for example: 000007ed9d5)) and subscribes to be notified when this subscription data is modified using Nudm_SDM_Subscribe (SUPI, Session Management Subscription data, selected DNN, S-NSSAI of the HPLMN, Serving PLMN ID, [NID] (Network Identifier)). UDM may get this information from UDR by Nudr_DM_Query (SUPI, Subscription Data, Session Management Subscription data, selected DNN, S-NSSAI of the HPLMN, Serving PLMN ID, [NID] (Network Identifier)) and may subscribe to notifications from UDR for the same data by Nudr_DM_subscribe.

In step 4, UDM respond to SMF with the requested session management subscription data, as one of the improved steps, the UDM response also includes additional information in DnnConfiguration of the session management data for the secondary authentication and authorization if secondary authentication and authorization is needed:
Secondary Authentication Method, indicating the method which shall be used for secondary authentication and authorization, wherein a new SBI based method towards an SBI-AAA server is introduced based on use case of FIG. 2, besides the existing EAP based methods towards a DN-AAA server;
Access information for SBI based authentication secondary Authentication Method: addresses, FQDNs or the SBI-AAA NF instance Id, wherein this information is optional. If not present, SMF shall get from UE or local configuration or rely on NEF to select the appropriate SBI-AAA server (which plays the role of an application function).

For the mentioned above improvements, a standard contribution may be proposed to 3GPP TS 29.503 to extend the session management subscription data, a first embodiment is as below (with the extended IEs underlined):
secondaryAuthMethod: indicating the method which shall be used for secondary authentication and authorization, which is an enumeration type of DN-AAA, SBI-AAA and could be extended with other new method in the future. For example, this parameter may include any one of the following values:
   “DN-AAA”: DN-AAA based secondary authentication and authorization shall be used;
   “SBI-AAA”: SBI based secondary authentication and authorization shall be used;
   “API-AAA”: (supposing in the future another kind of API (application programmable interface) based secondary authentication and authorization is supported) “API-AAA” indicating another API based secondary authentication and authorization shall be used
sbiAaaAddress: the IP address of the SBI-AAA server used for secondary authentication and authorization, for example: 192.168.1.3 is the IPV4 address of the SBI-AAA server, 240e:3a1:5662:4560:54e2:5e21:505a:8e12 is an IPv6 address of the SBI-AAA server;
additionalSbiAaaAddress: additional IP address of the SBI-AAA server used for secondary authentication and authorization, for example: 192.168.2.3 is an additional IPv4 address of the SBI-AAA server, 240e:3a1:5662:4560:54e2:5e21:505a:8e13 is an additional IPV6 address of the SBI-AAA server;
sbiAaaaFqdn: the FQDN of the SBI-AAA server used for secondary authentication and authorization, for example: sbiaaa.example.com is the FQDN of the SBI-AAA server;
sbiAaaNfId: NF Instance Id of the SBI-AAA NF, for example, “05c05d32-4830-4e56-9788-ad5b2589b3fd” could be the NF instance id of the SBI-AAA server.

First Amendments to “Table 6.1.6.2.9-1: Definition of type DnnConfiguration” in 3GPP TS 29.503

| Attribute name | Data type | P | Cardinality | Description |
|---|---|---|---|---|
| pduSessionTypes | PduSessionTypes | M | 1 | Default/Allowed session types |
| sscModes | SscModes | M | 1 | Default/Allowed SSC modes |
| iwkEpsInd | IwkEpsInd | O | 0 . . . 1 | Indicates whether interworking with |
| | | | | EPS is subscribed: |
| | | | | true: Subscribed; |
| | | | | false: Not subscribed; |
| | | | | If this attribute is absent it means not |
| | | | | subscribed. |
| 5gQosProfile | SubscribedDefault | O | 0 . . . 1 | 5G QoS parameters associated to the |
| | Qos | | | session for a data network |
| sessionAmbr | Ambr | O | 0 . . . 1 | The maximum aggregated uplink and |
| | | | | downlink bit rates to be shared across |
| | | | | all Non-GBR QoS Flows in each PDU |
| | | | | Session |
| 3 gppCharging | 3GppCharging | O | 0 . . . 1 | Subscribed charging characteristics |
| Characteristics | Characteristics | | | data associated to the session for a data |
| | | | | network. (NOTE 1) |
| staticIpAddress | array(IpAddress) | O | 1 . . . 2 | Subscribed static IP address(es) of the |
| | | | | IPv4 and/or IPv6 type |
| upSecurity | UpSecurity | O | 0 . . . 1 | When present, this IE shall indicate the |
| | | | | security policy for integrity protection |
| | | | | and encryption for the user plane. |
| pduSessionContinuityInd | PduSession | O | 0 . . . 1 | When present, this IE shall indicate |
| | ContinuityInd | | | how to handle a PDU Session when |
| | | | | UE the moves to or from NB-IoT. |
| | | | | If this attribute is absent it means that |
| | | | | Local policy shall be used. |
| niddNefId | NefId | C | O . . . 1 | Indicates the identity of the NEF to be |
| | | | | selected for NIDD service for this |
| | | | | DNN. It is required if |
| | | | | invokeNefSelection attribute is present |
| | | | | with value “true”. |
| niddInfo | NiddInformation | O | 0 . . . 1 | When present, this IE shall indicate |
| | | | | information used for SMF-NEF |
| | | | | Connection. |
| | | | | This attribute may be present if |
| | | | | “Invoke NEF Selection” indicator is |
| | | | | set. |
| redundantSession | boolean | O | 0 . . . 1 | Indicates whether redundant PDU |
| Allowed | | | | Sessions are allowed: |
| | | | | true: Allowed; |
| | | | | false: Not allowed; |
| | | | | If this attribute is absent it means not |
| | | | | allowed. |
| acsInfo | AcsInfo | O | 0 . . . 1 | When present, this IE shall include the |
| | | | | ACS information for the 5G-RG as |
| | | | | defined in BBF TR-069 [42] or in |
| | | | | BBF TR-369 [43]. |
| ipv4FrameRouteList | array(FrameRoute | O | 1 . . . N | List of Frame Route information of |
| | Info) | | | IPv4, see clause 5.6.14 of |
| | | | | 3GPP TS 23.501 [2]. |
| ipv6FrameRouteList | array(FrameRoute | O | 1 . . . N | List of Frame Route information of |
| | Info) | | | IPv6, see clause 5.6.14 of |
| | | | | 3GPP TS 23.501 [2]. |
| atsssAllowed | boolean | O | 0 . . . 1 | Indicates whether this DNN supports |
| | | | | ATSSS, i.e. whether Multi-Access |
| | | | | PDU session is allowed to this DNN. |
| | | | | true: Allowed; |
| | | | | false (default): Not allowed; |
| | | | | If this attribute is absent it means this |
| | | | | DNN does not allow ATSSS. |
| secondaryAuth | boolean | O | 0 . . . 1 | Indicates whether secondary |
| | | | | authentication and authorization is |
| | | | | needed. |
| | | | | true: required. |
| | | | | false: not required. |
| | | | | If absent, it indicates that secondary |
| | | | | authentication is not required by |
| | | | | subscription data, but it still may be |
| | | | | required by local policies at the SMF. |
| | | | | (NOTE 2) |
| secondary AuthMethod | SecondaryAuth | O | 0 . . . 1 | Indicates the method shall be used for |
| | Method | | | secondary authentication and |
| | | | | authorization. |
| sbiAaaAddress | IpAddress | O | 0 . . . 1 | The IP address of the SBI-AAA server |
| | | | | used for secondary authentication and |
| | | | | authorization. |
| additionalSbiAaa | array(IpAddress) | O | 1 . . . N | Additional IP addresses of the SBI- |
| Addresses | | | | AAA server used for secondary |
| | | | | authentication and authorization |
| sbiAaaaFqdn | Fqdn | O | 0 . . . 1 | The FQDN of the SBI-AAA server |
| | | | | used for secondary authentication and |
| | | | | authorization |
| sbiAaaNfId | NfInstanceId | O | 1 | NF Instance Id of the SBI-AAA NF |
| dnAaaIpAddress | boolean | O | 0 . . . 1 | Indicates whether the SMF is required |
| Allocation | | | | to request the UE IP address from the |
| | | | | DN-AAA server for PDU Session |
| | | | | Establishment. |
| | | | | true: required |
| | | | | false: not required |
| | | | | If absent, it indicates that the request |
| | | | | by SMF of the UE IP address from the |
| | | | | DN-AAA server is not required by |
| | | | | subscription data, but it still may be |
| | | | | required by local policies at the SMF. |
| dnAaaAddress | IpAddress | O | 0 . . . 1 | The IP address of the DN-AAA server |
| | | | | used for secondary authentication and |
| | | | | authorization. |
| | | | | (NOTE 2) |
| additionalDnAaa | array(IpAddress) | O | 1 . . . N | Additional IP addresses of the DN- |
| Addresses | | | | AAA server used for secondary |
| | | | | authentication and authorization. |
| | | | | (NOTE 2) |
| dnAaaFqdn | Fqdn | O | 0 . . . 1 | The FQDN of the DN-AAA server |
| | | | | used for secondary authentication and |
| | | | | authorization. |
| | | | | (NOTE 2) |
| iptvAccCtrlInfo | string | O | 0 . . . 1 | The IPTV access control information |
| | | | | used in IPTV access procedure, see |
| | | | | clause 7.7.1.1.2 of |
| | | | | 3GPP TS 23.316 [37]. |
| ipv4Index | IpIndex | O | 0 . . . 1 | Indicates the “IP Index” (i.e. |
| | | | | information that identifies an address |
| | | | | pool or an external server) to be sent to |
| | | | | the SMF for allocation of an IPv4 |
| | | | | address to the UE, for this DNN |
| | | | | configuration. |
| ipv6Index | IpIndex | O | 0 . . . 1 | Indicates the “IP Index” (i.e. |
| | | | | information that identifies an address |
| | | | | pool or an external server) to be sent to |
| | | | | the SMF for allocation of an IPv6 |
| | | | | address to the UE, for this DNN |
| | | | | configuration. |
| ecsAddrConfigInfo | EcsAddrConfig | O | 0 . . . 1 | ECS Address Configuration Informatio |
| | Info | | | Parameters. See 3GPP TS 23.502 [3] |
| sharedEcsAddr | SharedDataId | O | 0 . . . 1 | Identifier of shared data. May be |
| ConfigInfoId | | | | present if ecsAddrConfigInfo is absent. |
| easDiscovery | boolean | O | 0 . . . 1 | Indicates whether the UE is authorized |
| Authorized | | | | to use 5GC assisted EAS discovery via |
| | | | | EASDF. |
| | | | | true: Authorized; |
| | | | | false (default): Not authorized; |
| | | | | See 3GPP TS 23.548 [60] |
| onboardingInd | boolean | O | 0 . . . 1 | Indicates whether the UE is allowed to |
| | | | | use this DNN for onboarding. UE |
| | | | | subscription allows, or does not allow |
| | | | | the UE to access the PLMN as the |
| | | | | Onboarding Network using PLMN |
| | | | | credentials (see clause 5.30.2.10.4.4 in |
| | | | | 3GPP TS 23.501 [2]). |
| | | | | false (default): not restricted to |
| | | | | onboarding only; |
| | | | | true: allowed for onboarding |
| | | | | only. |
| aerialUeInd | AerialUe | O | 0 . . . 1 | This IE shall indicate Aerial service for |
| | Indication | | | the UE is allowed or not allowed. |

NOTE 1:
When present, this attribute shall take precedence over the “3gppChargingCharacteristics” attribute in the SessionManagementSubscriptionDatalevel.
NOTE 2:
These attributes shall be consistent with the information received on the 5GVnGroupData (see clause 6.5.6.2.7), in the Nudm_PP API. If both FQDN and IP addresses are provided, the IP addresses should be preferred to target the DN-AAA server.

The second embodiment is as below (with the extended IEs underlined):
sbiSecondaryAuth: indicating whether the SBI based secondary authentication and authorization is needed, with this embodiment, the original secondaryAuth shall be degraded to only indicate whether DN-AAA based secondary authentication and authorization method shall be used, and can't be true in parallel with new IE
sbiSecondary Auth. For example, “true” means SBI based secondary authentication and authorization is required; “false” or absent means SBI based secondary authentication and authorization is not required;
sbiAaaAddress: the IP address of the SBI-AAA server used for secondary authentication and authorization;
additionalSbiAaaAddress: additional IP address of the SBI-AAA server used for secondary authentication and authorization;
sbiAaaaFqdn: the FQDN of the SBI-AAA server used for secondary authentication and authorization;
sbiAaaNfId: NF Instance Id of the SBI-AAA NF.

For example, when this indication sbiSecondaryAuth is related to uav in some scenarios, it may be also named as uavSecondaryAuth.

Second Amendments to “Table 6.1.6.2.9-1: Definition of type DnnConfiguration” in 3GPP TS 29.503

| Attribute name | Data type | P | Cardinality | Description |
|---|---|---|---|---|
| pduSessionTypes | PduSessionTypes | M | 1 | Default/Allowed session types |
| sscModes | SscModes | M | 1 | Default/Allowed SSC modes |
| iwkEpsInd | IwkEpsInd | O | 0 . . . 1 | Indicates whether interworking with |
| | | | | EPS is subscribed: |
| | | | | true: Subscribed; |
| | | | | false: Not subscribed; |
| | | | | If this attribute is absent it means not |
| | | | | subscribed. |
| 5gQosProfile | Subscribed | O | 0 . . . 1 | 5G QoS parameters associated to the |
| | DefaultQos | | | session for a data network |
| sessionAmbr | Ambr | O | 0 . . . 1 | The maximum aggregated uplink and |
| | | | | downlink bit rates to be shared across |
| | | | | all Non-GBR QoS Flows in each PDU |
| | | | | Session |
| 3gppCharging | 3GppCharging | O | 0 . . . 1 | Subscribed charging characteristics |
| Characteristics | Characteristics | | | data associated to the session for a data |
| | | | | network. (NOTE 1) |
| staticIpAddress | array(IpAddress) | O | 1 . . . 2 | Subscribed static IP address(es) of the |
| | | | | IPv4 and/or IPv6 type |
| upSecurity | UpSecurity | O | 0 . . . 1 | When present, this IE shall indicate the |
| | | | | security policy for integrity protection |
| | | | | and encryption for the user plane. |
| pduSession | PduSession | O | 0 . . . 1 | When present, this IE shall indicate |
| ContinuityInd | ContinuityInd | | | how to handle a PDU Session when |
| | | | | UE the moves to or from NB-IoT. |
| | | | | If this attribute is absent it means that |
| | | | | Local policy shall be used. |
| niddNefId | NefId | C | 0 . . . 1 | Indicates the identity of the NEF to be |
| | | | | selected for NIDD service for this |
| | | | | DNN. It is required if |
| | | | | invokeNefSelection attribute is present |
| | | | | with value “true”. |
| niddInfo | NiddInformation | O | 0 . . . 1 | When present, this IE shall indicate |
| | | | | information used for SMF-NEF |
| | | | | Connection. |
| | | | | This attribute may be present if |
| | | | | “Invoke NEF Selection” indicator is |
| | | | | set. |
| redundantSession | boolean | O | 0 . . . 1 | Indicates whether redundant PDU |
| Allowed | | | | Sessions are allowed: |
| | | | | true: Allowed; |
| | | | | false: Not allowed; |
| | | | | If this attribute is absent it means not |
| | | | | allowed. |
| acsInfo | AcsInfo | O | 0 . . . 1 | When present, this IE shall include the |
| | | | | ACS information for the 5G-RG as |
| | | | | defined in BBF TR-069 [42] or in |
| | | | | BBF TR-369 [43]. |
| ipv4FrameRoute | array(Frame | O | 1 . . . N | List of Frame Route information of |
| List | RouteInfo) | | | IPv4, see clause 5.6.14 of |
| | | | | 3GPP TS 23.501 [2]. |
| ipv6FrameRoute | array(Frame | O | 1 . . . N | List of Frame Route information of |
| List | RouteInfo) | | | IPv6, see clause 5.6.14 of |
| | | | | 3GPP TS 23.501 [2]. |
| atsssAllowed | boolean | O | 0 . . . 1 | Indicates whether this DNN supports |
| | | | | ATSSS, i.e. whether Multi-Access |
| | | | | PDU session is allowed to this DNN. |
| | | | | true: Allowed; |
| | | | | false (default): Not allowed; |
| | | | | If this attribute is absent it means this |
| | | | | DNN does not allow ATSSS. |
| secondaryAuth | boolean | O | 0 . . . 1 | Indicates whether secondary |
| | | | | authentication |
| | | | | and authorization is needed. |
| | | | | true: required. |
| | | | | false: not required. |
| | | | | If absent, it indicates that secondary |
| | | | | authentication is not required by |
| | | | | subscription data, but it still may be |
| | | | | required by local policies at the SMF. |
| | | | | (NOTE 2) |
| sbiSecondaryAuth | boolean | O | 0 . . . 1 | Indicates whether the SBI based |
| | | | | secondary authentication and |
| | | | | authorization is needed. |
| sbiAaaAddress | IpAddress | O | 0 . . . 1 | The IP address of the SBI-AAA server |
| | | | | used for secondary authentication and |
| | | | | authorization. |
| additionalSbiAaa | array(IpAddress) | O | 1 . . . N | Additional IP addresses of the SBI- |
| Addresses | | | | AAA server used for secondary |
| | | | | authentication and authorization |
| sbiAaaaFqdn | Fqdn | O | 0 . . . 1 | The FQDN of the SBI-AAA server |
| | | | | used for secondary authentication and |
| | | | | authorization |
| sbiAaaNfId | NfInstanceId | O | 1 | NF Instance Id of the SBI-AAA NF |
| dnAaaIpAddress | boolean | O | 0 . . . 1 | Indicates whether the SMF is required |
| Allocation | | | | to request the UE IP address from the |
| | | | | DN-AAA server for PDU Session |
| | | | | Establishment. |
| | | | | true: required |
| | | | | false: not required |
| | | | | If absent, it indicates that the request |
| | | | | by SMF of the UE IP address from the |
| | | | | DN-AAA server is not required by |
| | | | | subscription data, but it still may be |
| | | | | required by local policies at the SMF. |
| dnAaaAddress | IpAddress | O | 0 . . . 1 | The IP address of the DN-AAA server |
| | | | | used for secondary authentication and |
| | | | | authorization. |
| | | | | (NOTE 2) |
| additionalDnAaa | array(IpAddress) | O | 1 . . . N | Additional IP addresses of the DN- |
| Addresses | | | | AAA server used for secondary |
| | | | | authentication and authorization. |
| | | | | (NOTE 2) |
| dnAaaFqdn | Fqdn | O | 0 . . . 1 | The FQDN of the DN-AAA server |
| | | | | used for secondary authentication and |
| | | | | authorization. |
| | | | | (NOTE 2) |
| iptvAccCtrlInfo | string | O | 0 . . . 1 | The IPTV access control information |
| | | | | used in IPTV access procedure, see |
| | | | | clause 7.7.1.1.2 of |
| | | | | 3GPP TS 23.316 [37]. |
| ipv4Index | IpIndex | O | 0 . . . 1 | Indicates the “IP Index” (i.e. |
| | | | | information that identifies an address |
| | | | | pool or an external server) to be sent to |
| | | | | the SMF for allocation of an IPv4 |
| | | | | address to the UE, for this DNN |
| | | | | configuration. |
| ipv6Index | IpIndex | O | 0 . . . 1 | Indicates the “IP Index” (i.e. |
| | | | | information that identifies an address |
| | | | | pool or an external server) to be sent to |
| | | | | the SMF for allocation of an IPv6 |
| | | | | address to the UE, for this DNN |
| | | | | configuration. |
| ecsAddrConfigInfo | EcsAddrConfig | O | 0 . . . 1 | ECS Address Configuration Informatio |
| | Info | | | Parameters. See 3GPP TS 23.502 [3] |
| sharedEcsAddr | SharedDataId | O | 0 . . . 1 | Identifier of shared data. May be |
| ConfigInfoId | | | | present if ecsAddrConfigInfo is absent. |
| easDiscovery | boolean | O | 0 . . . 1 | Indicates whether the UE is authorized |
| Authorized | | | | to use 5GC assisted EAS discovery via |
| | | | | EASDF. |
| | | | | true: Authorized; |
| | | | | false (default): Not authorized; |
| | | | | See 3GPP TS 23.548 [60] |
| onboardingInd | boolean | O | 0 . . . 1 | Indicates whether the UE is allowed to |
| | | | | use this DNN for onboarding. UE |
| | | | | subscription allows, or does not allow |
| | | | | the UE to access the PLMN as the |
| | | | | Onboarding Network using PLMN |
| | | | | credentials (see clause 5.30.2.10.4.4 in |
| | | | | 3GPP TS 23.501 [2]). |
| | | | | false (default): not restricted to |
| | | | | onboarding only; |
| | | | | true: allowed for onboarding |
| | | | | only. |
| aerialUeInd | AerialUe | O | 0 . . . 1 | This IE shall indicate Aerial service for |
| | Indication | | | the UE is allowed or not allowed. |

NOTE 1:
When present, this attribute shall take precedence over the “3gppChargingCharacteristics” attribute in the SessionManagementSubscriptionDatalevel.
NOTE 2:
These attributes shall be consistent with the information received on the 5GVnGroupData (see clause 6.5.6.2.7), in the Nudm_PP API. If both FQDN and IP addresses are provided, the IP addresses should be preferred to target the DN-AAA server.

In step 5, if the SMF received Nsmf_PDUSession_CreateSMContext Request in step 2 and the SMF is able to process the PDU Session establishment request, the SMF creates an SM (session management) context and responds to the AMF by providing an SM Context ID (for example: “smcontext-1”).

In step 6, SMF checks the received session management subscription data from UDM in step 4 and further checks whether to perform the secondary authentication and authorization, and if yes further checks how to perform the secondary authentication and authorization for this PDU session request. The is step may further comprise:
checking whether secondary authentication and authorization is needed. If in first embodiment, the secondaryAuth IE is checked to determine whether secondary authentication and authorization is needed. If in second embodiment, both secondaryAuth and sbiSecondaryAuth IEs are checked to determine whether secondary authentication and authorization is needed;
checking which method shall be used for the secondary authentication and authorization. If in first embodiment, secondaryAuthMethod IE is checked to know which method is used, DN-AAA or SBI-AAA. If in second embodiment, when secondaryAuth is enabled the corresponding method for secondary authentication and authorization shall be DN-AAA based, when sbiSecondaryAuth is enabled then corresponding method for secondary authentication and authorization shall be SBI-AAA based;
checking the access information for selected method. It is the same way for both embodiments, DN-AAA access information is obtained from dnAaaAddress/additionalDnAaaAddresses/dnAaaFqdn IEs, and SBI-AAA access information is from sbiAaaAddress/additionalSbiAaaAddresses/sbiAaaaFqdn/sbiAaNfid.

The procedure will go the steps 7-14 for DN-AAA.

In step 7, if the method for secondary authentication and authorization is DN-AAA based (for example: “secondaryAuthMethod” is “DN-AAA” in the 1^{st} embodiment, or secondaryAuth is “true” in the 2^{nd} embodiment), then SMF initiate EAP based authentication and authorization towards the DN-AAA server based on DN-AAA access information (for example: dnAaaAddress indicates IPv4 address: 192.168.3.3).

In step 8, the SMF shall send an EAP Request/Identity message to the UE.

In step 9, the UE shall send an EAP Response/Identity message contained within the SM PDU DN Request Container of a NAS message. The SM PDU DN Request Container includes its DN-specific identity complying with Network Access Identifier (NAI) format (for example: id1@dn1.example.com) and PDU session ID.

In step 10, if there is no existing N4 session, the SMF selects a UPF and establishes an N4 Session with it. The SM PDU DN Request Container, if provided by the UE, is forwarded to the UPF. The SMF identifies the DN AAA server based on the DN-AAA access information.

In step 11, the UPF shall forward the SM PDU DN Request Container containing EAP Response/Identity message to the DN AAA Server.

In step 12, the DN AAA server and the UE shall exchange EAP messages, as required by the EAP method, contained in the SM PDU DN Request Containers.

In step 13, after the successful completion of the authentication procedure, DN AAA server shall send EAP Success message to the SMF.

In step 14, this completes the authentication procedure at the SMF. The SMF may save the DN-specific ID and DNN (or DN's AAA server ID if available) in a list for successful authentication/authorization between UE and an SMF.

The procedure will go the steps 15-19 for SBI-AAA.

In step 15, if the method for secondary authentication and authorization is SBI-AAA based (for example: “secondaryAuthMethod” is “SBI-AAA” in the 1^{st} embodiment, or sbiSecondaryAuth is “true” in the 2^{nd} embodiment), then SMF initiate SBI based authentication and authorization towards the SBI-AAA server based on SBI-AAA access information.

In step 16, the SMF invokes Nnef_Authentication_AuthenticateAuthorize service operation, including the Service Level Device Identity, and may include the SBI-AAA Server Address from SBI-AAA access information. NEF invokes Naf_Authentication_AuthenticateAuthorize service operation forwarding the authentication request received information from the SMF.

Nnef_Authentication_AuthenticateAuthorize service operation provides the authentication and authorization result of the service level device identity:
the request input parameters may include the service level device identity for authentication (for example a CAA (Civil Aviation Authority)-Level UAV-ID or other service specific device identity like “Operator1-ServiceCode1-DeviceId1”), GPSI (Generic Public Subscription Identifier) (for example: mssidn-8613912345678), NF type (for example: “SMF”), notification endpoint (for example: https://smfnotif1.example.com), DNN (for example: “USS”), S-NSSAI (for example: {sst: 128, sd: USS001}), SBI-AAA server address (for example: 192.168.1.3), PEI (Permanent Equipment Identifier) (for example: imei (International Mobile Equipment Identity)-868668067841436), UE IP address (for example: 192.168.1.100), authentication/authorization msg (for example an access request msg depends on the using authentication method), UE location (for example: cellId-1) etc.

Naf_Authentication_AuthenticateAuthorize service operation provides the Authentication and Authorization result of the Service Level Device Identity:
the request input parameters may include service level device identity for authentication (for example a CAA-Level UAV-ID or other service specific device identity like “Operator1-ServiceCode1-DeviceId1”), GPSI (for example: msisdn-8613912345678), notification endpoint (for example: https://nefnotif1.example.com), PEI (for example: imei-868668067841436), UE IP address (for example: 192.168.1.100), authentication/authorization msg (for example an access request msg depends on the using authentication method), UE location (for example: cellId-1) etc.

In step 17, the SBI AAA server and the UE shall exchange Authentication messages, as required by the authentication method, contained in the NAS SM transport messages.

In step 18, the SBI-AAA sends Naf_Authentication_AuthenticateAuthorize response to the NEF with the Authentication/Authorization result, The NEF confirms the successful Authentication/Authorization of the PDU Session to SMF.

Naf_Authentication_AuthenticateAuthorize service operation provides the Authentication and Authorization result of the Service Level Device Identity:
the response output parameters may include Success/Failure indication (for example: “SUCCESS”), GPSI (for example: msisdn-8613912345678), authorization data (for example an access accept message depends on the using authentication method) etc.

Nnef_Authentication_AuthenticateAuthorize service operation provides the authentication and authorization result of the service level device identity:
the response out parameters may include Success/Failure indication (for example: “SUCCESS”), GPSI (for example: msisdn-8613912345678), authorization data (an access accept message depends on the using authentication method) etc.

In step 19, this completes the authentication procedure at the SMF.

In step 20, if the authorization is successful, PDU Session Establishment proceeds further continues.

In step 21, the SMF sends Namf_Communication_NIN2MessageTransfer to the AMF. This message shall include Authentication/Authorization result to be sent to the UE within the NAS SM PDU Session Establishment Accept message.

In step 22, the AMF forwards NAS SM PDU Session Establishment Accept message along with Authentication/Authorization result to the UE.

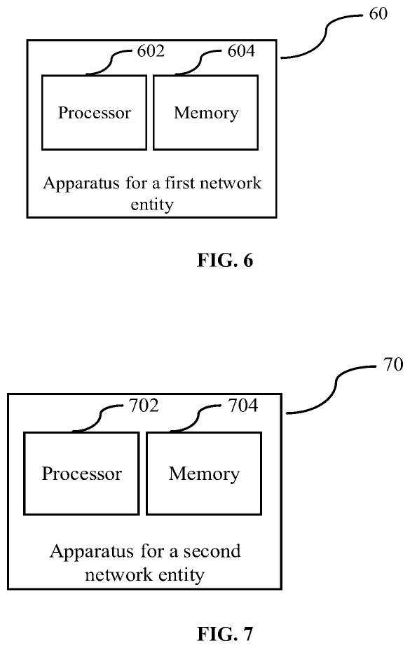

FIG. 6 is a block diagram showing an exemplary apparatus for a first network entity, which is suitable for perform the method according to embodiments of the disclosure.

As shown in FIG. 6, an apparatus 60 for a first network entity in a communication network comprises: a processor 602; and a memory 604. The memory contains instructions executable by the processor. The apparatus for the first network entity is operative for: receiving from a second network entity a message indicating at least one kind of a secondary authentication/authorization method. One of the at least one kind of a secondary authentication/authorization method is a service based interface, SBI, -based secondary authentication/authorization.

In embodiments of the present disclosure, the apparatus 60 is further operative to perform the method according to any of the above embodiments, such as these shown in FIG. 3, 5A, 5B.

FIG. 7 is a block diagram showing an exemplary apparatus for a second network entity, which is suitable for perform the method according to embodiments of the disclosure.

As shown in FIG. 7, an apparatus 70 for a second network entity in a communication network comprises: a processor 702; and a memory 704. The memory contains instructions executable by the processor. The apparatus for the second network entity is operative for: transmitting to a first network entity a message indicating at least one kind of a secondary authentication/authorization method. One of the at least one kind of a secondary authentication/authorization method is SBI-based secondary authentication/authorization.

In embodiments of the present disclosure, the apparatus 70 is further operative to perform the method according to any of the above embodiments, such as these shown in FIG. 4, 5A, 5B.

The processors 602, 702 may be any kind of processing component, such as one or more microprocessor or microcontrollers, as well as other digital hardware, which may include digital signal processors (DSPs), special-purpose digital logic, and the like. The memories 604, 704 may be any kind of storage component, such as read-only memory (ROM), random-access memory, cache memory, flash memory devices, optical storage devices, etc.

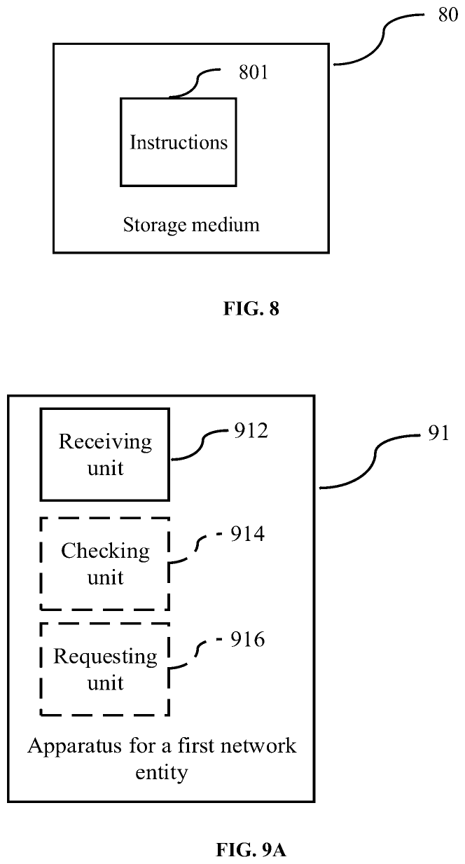

FIG. 8 is a block diagram showing an apparatus/computer readable storage medium, according to embodiments of the present disclosure.

As shown in FIG. 8, the computer-readable storage medium 80, or any other kind of product, storing instructions 801 which when executed by at least one processor, cause the at least one processor to perform the method according to any one of the above embodiments, such as these shown in FIG. 3, 4, 5A, 5B.

In addition, the present disclosure may also provide a carrier containing the computer program as mentioned above, the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

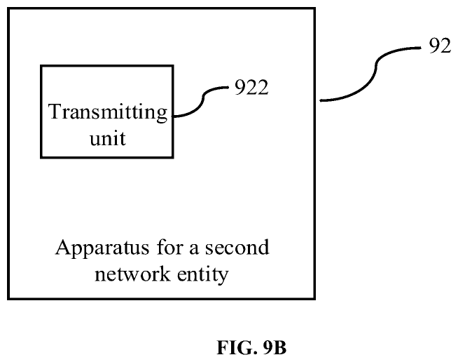

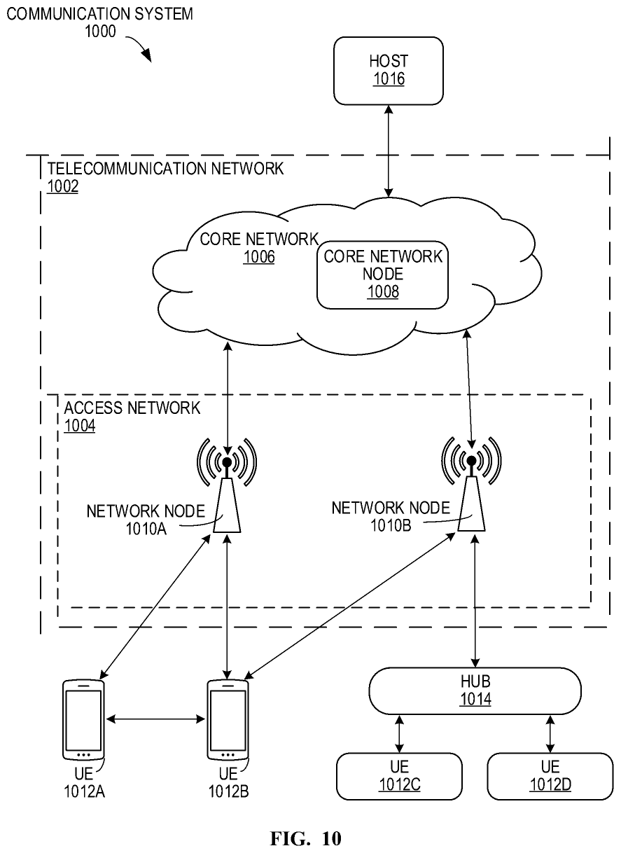

FIG. 9A is a block diagram showing units of an exemplary apparatus for a first network entity, which is suitable for perform the method according to embodiments of the disclosure.

As shown in FIG. 9A, an apparatus 91 for a first network entity in a communication network may comprise: a receiving unit 912, configured to receive from a second network entity a message indicating at least one kind of a secondary authentication/authorization method; a checking unit 914, configured to check the message to decide whether the secondary authentication/authorization is required and/or which kind of secondary authentication/authorization method is to be used; and/or a requesting unit 916, configured to request a third network entity to perform the secondary authentication/authorization based on the kind of secondary authentication/authorization method.

In embodiments of the present disclosure, the apparatus 91 is further operative to perform the method according to any of the above embodiments, such as these shown in FIG. 3, 5A, 5B.

FIG. 9B is a block diagram showing units of an exemplary apparatus for a third network entity, which is suitable for perform the method according to embodiments of the disclosure.

As shown in FIG. 9B, an apparatus 92 for a third network entity in a communication network may comprise: a transmitting unit 922, configured to transmitting to a first network entity a message indicating at least one kind of a secondary authentication/authorization method. The kind of secondary authentication/authorization method may be selected from a plurality of kinds of secondary authentication/authorization method. The first network entity requests a third network entity to perform the secondary authentication/authorization, based on the kind of secondary authentication/authorization method.

In embodiments of the present disclosure, the apparatus 92 is further operative to perform the method according to any of the above embodiments, such as these shown in FIG. 4, 5A, 5B.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

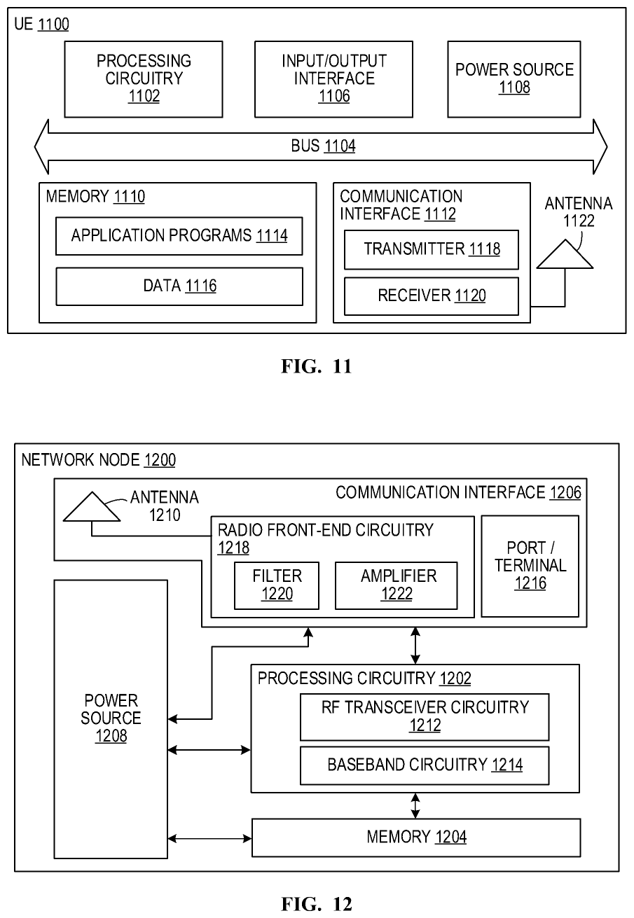

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

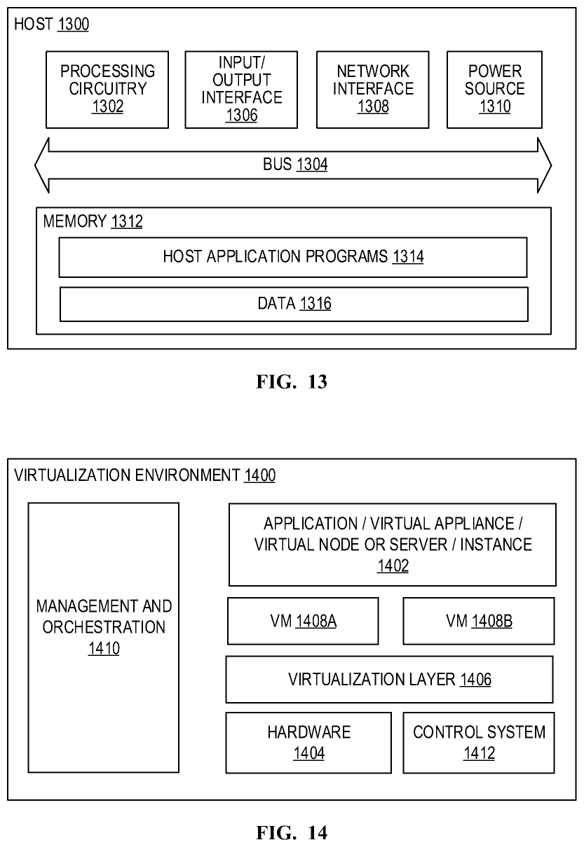

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

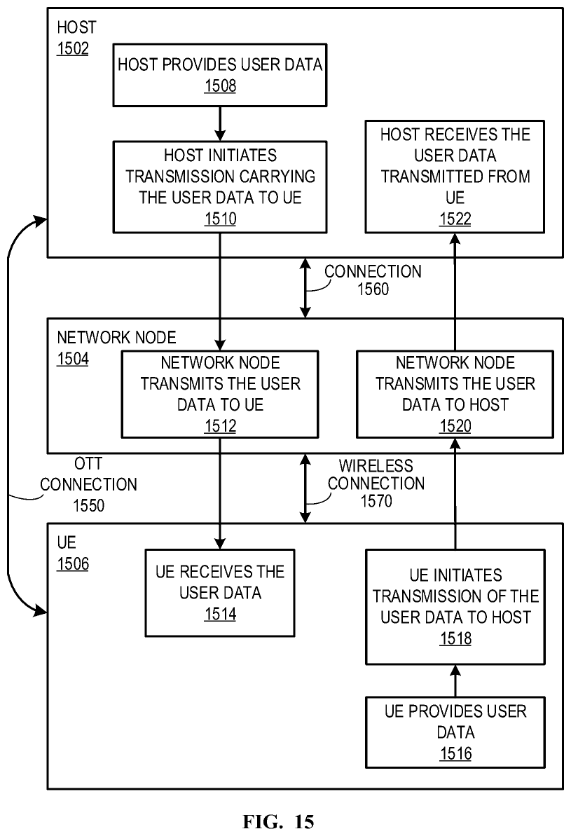

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, an improved manner for performing secondary authentication/authorization for a terminal device in a communication network may be provided. Particularly, embodiments of the present disclosure may provide a more flexible/dynamic mechanism for secondary authentication/authorization. Multiple methods of secondary authentication/authorization may be supported in the communication network. For different use cases, the method for secondary authentication/authorization may be selected accordingly. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

REFERENCE
3GPP TS 23.502 V 17.3.0
3GPP TS 33.501 V17.4.2
3GPP TS 29.503 V17.6.0

| ABBREVIATION | EXPLANATION |
|---|---|
| 3GPP TS | Third generation partnership project technical specification |
| PDU | Protocol data unit |
| DN | Data Network |
| UDM | Unified Data Management |
| NEF | Network Exposure Function |
| EAP | Extended Authentication Protocol |
| AAA | Authentication, Authorization and Accounting |
| TPAE | Third Party Authorized Entity |
| UAS | Uncrewed Aerial System |
| UAV | Uncrewed Aerial Vehicle |
| USS | UAS Service Supplier |
| SMF | Session Management Function |
| AMF | Access and Mobility Management Function |
| UPF | User Plane Function |
| NSSAF | Network Slice Specific Authentication and Authorization Function |
| SBI | Service Based Interface |
| NG-RAN | Next Generation-Radio Access Netowork |
| NF | Network Function |
| PCF | Policy Control Function |
| PCEF | Policy and Charging Enforcement Function |
| PCRF | Policy and Charging Rules Function |
| H-PCRF | Home Policy and Charging Rules Function |
| PDR | Packet Detection Rule |
| URR | Usage Report Rule |
| PGW-C | Packet data network gateway-control plane |
| PGW-U | Packet data network gateway-user plane |
| PCC | Policy control and charging |
| QoS | Quality of service |
| PRA | Presence Reporting Area |

1-33. (canceled)

34. A method performed by a first network entity, comprising:
receiving, from a second network entity, a message indicating at least one kind of a secondary authentication/authorization method, wherein one of the at least one kind of a secondary authentication/authorization method is a service based interface (SBI)-based secondary authentication/authorization.

35. The method according to claim 34, wherein the at least one kind of the secondary authentication/authorization method further comprises: another kind of a data network-authentication, authorization and accounting (DN-AAA) based secondary authentication/authorization method.

36. The method according to claim 34, further comprising:
checking the message to decide whether the secondary authentication/authorization is required and/or which kind of secondary authentication/authorization method is to be used.

37. The method according to claim 36, further comprising:
requesting a third network entity to perform the secondary authentication/authorization, based on the kind of secondary authentication/authorization method.

38. The method according to claim 37,
wherein the message further includes access information for the first network entity to access the third network entity.

39. The method according to claim 34,
wherein the message includes a first indication for the SBI-based secondary authentication/authorization method and/or a second indication for a data network-authentication, authorization and accounting (DN-AAA) based secondary authentication/authorization method.

40. The method according to claim 39,
wherein the message indicates the DN-AAA based secondary authentication/authorization method;
wherein a third network entity is a DN-AAA server; and
wherein the message includes access information for the first network entity to access the DN-AAA server.

41. The method according to claim 40,
wherein the access information includes at least one of: an address of the DN-AAA server; an additional address of the DN-AAA server; or a domain name of the DN-AAA server.

42. The method according to claim 41,
wherein the first network entity accesses the third network entity directly or via a user plane function (UPF).

43. The method according to claim 34,
wherein the first network entity comprises a session management function (SMF);
wherein the second network entity comprises a unified data management (UDM); and
wherein the message is a response to a request for session management data.

44. A method performed by a second network entity, comprising:
transmitting, to a first network entity, a message indicating at least one kind of a secondary authentication/authorization method, wherein one of the at least one kind of a secondary authentication/authorization method is service based interface (SBI)-based secondary authentication/authorization.

45. The method according to claim 44, wherein the at least one kind of the secondary authentication/authorization method further comprises another kind of a data network-authentication, authorization and accounting (DN-AAA)-based secondary authentication/authorization method.

46. The method according to claim 44,
wherein the first network entity checks the message to decide whether the secondary authentication/authorization is required and/or which kind of secondary authentication/authorization method is to be used.

47. The method according to claim 46,
wherein the first network entity requests a third network entity to perform the secondary authentication/authorization, based on the kind of secondary authentication/authorization method.

48. The method according to claim 47,
wherein the message further includes access information for the first network entity to access the third network entity.

49. The method according to claim 44,
wherein the message includes a first indication for an SBI-based secondary authentication/authorization method and/or a second indication for a data network-authentication, authorization and accounting (DN-AAA)-based secondary authentication/authorization method.

50. The method according to claim 49,
wherein the message indicates the DN-AAA based secondary authentication/authorization method;
wherein a third network entity is a DN-AAA server; and
wherein the message includes access information for the first network entity to access the DN-AAA server.

51. The method according to claim 50,
wherein the access information includes at least one of: an address of the DN-AAA server; an additional address of the DN-AAA server; or a domain name of the DN-AAA server.

52. The method according to claim 50,
wherein the first network entity accesses the third network entity directly or via a user plane function (UPF).

53. An apparatus for a first network entity in a communication network, comprising:
a processor; and
a memory, the memory containing instructions executable by the processor, whereby the apparatus for the first network entity is operative for:
receiving, from a second network entity, a message indicating at least one kind of a secondary authentication/authorization method, wherein one of the at least one kind of a secondary authentication/authorization method is a service based interface (SBI)-based secondary authentication/authorization.
